(19) United States
(12) Patent Application Publication
(10) Pub. No.: US 2025/0071385 A1
(43) Pub. Date: Feb. 27, 2025

(54) DISPLAY DEVICE AND OPERATING METHOD THEREOF

(71) Applicant: LG ELECTRONICS INC., Seoul (KR)

(72) Inventor: Youngman JUNG, Seoul (KR)

(73) Assignee: LG ELECTRONICS INC., Seoul (KR)

(21) Appl. No.: 18/802,910

(22) Filed: Aug. 13, 2024

(30) Foreign Application Priority Data
Aug. 23, 2023 (KR) 10-2023-0110705

(51) Int. Cl. H04N 21/4725; H04N 21/422; H04N 21/431

(52) U.S. Cl. CPC H04N 21/4725; H04N 21/4316; H04N 21/42204

(57) ABSTRACT

A display device according to at least one of various embodiments of the present disclosure can comprise a memory; a display configured to provide a screen; and a processor configured to call first data to be used in a search routine from the memory, when second data corresponding to the first data is searched from the screen being provided, call information about at least one of functions and applications that are mapped and stored in advance with the first data from the memory, and control the called function or application to be executed.

### CROSS-REFERENCE TO RELATED APPLICATION(S)

Pursuant to 35 U.S.C. § 119 (a), this application claims the benefit of earlier filing date and right of priority to Korean Patent Application No. 10-2023-0110705, filed on Aug. 23, 2023, the contents of which are all hereby incorporated by reference herein in their entireties.

### BACKGROUND OF THE INVENTION

### 1. Field of the Invention

The present disclosure relates to a display device and an operating method thereof.

### 2. Discussion of the Related Art

Recently, the functions of terminals have become more diverse, for example, data and voice communication, taking pictures and videos through cameras, recording voices, playing music files through speaker systems, and outputting images or videos to displays.

Some terminals have added electronic game play functions or perform multimedia player functions.

As the functions of these terminals have become more diverse, they are being implemented in the form of multimedia players with complex functions, such as taking pictures or videos, playing music or video files, playing games, and receiving broadcasts.

### SUMMARY OF THE INVENTION

An object of the present disclosure is to provide a display device and an operating method thereof that causes a routine corresponding to a searched data to be executed when predetermined data is searched (or detected) from an information area such as content provided through a screen.

A display device according to at least one of various embodiments of the present disclosure can comprise a memory; a display configured to provide a screen; and a processor configured to call first data to be used in a search routine from the memory, when second data corresponding to the first data is searched from the screen being provided, call information about at least one of functions and applications that are mapped and stored in advance with the first data from the memory, and control the called function or application to be executed.

According to at least one of the various embodiments of the present disclosure, the processor can acquire the first data, and control to provide an interface for setting up a routine by mapping at least one of an executable function and application to the first data acquired.

According to at least one of the various embodiments of the present disclosure, the processor can provide a tool according to a capture request for a screen that is being provided on the display, and acquire the first data from one area within a selected screen using the tool.

According to at least one of the various embodiments of the present disclosure, the processor can download and acquire the first data from a server.

According to at least one of the various embodiments of the present disclosure, the processor can provide a list of recommendations including executable functions and applications for the first data acquired according to a selection for the interface.

According to at least one of the various embodiments of the present disclosure, the processor can search second data corresponding to the first data from the screen being provided when a request for setting a search routine is acquired.

According to at least one of the various embodiments of the present disclosure, the first data can be in at least one of formats of image, text, and voice.

A method of operating a display device according to at least one of various embodiments of the present disclosure can comprise providing a screen; calling first data to be used in a search routine; searching for second data corresponding to the first data from the screen being provided; calling information about at least one of functions and applications that are mapped and stored in advance with the first data when the second data is searched; and executing a function or an application based on the called information.

According to at least one of the various embodiments of the present disclosure, the method of operating a display device can further comprise acquiring the first data, and controlling to provide an interface for setting up a routine by mapping at least one of an executable function and application to the first data acquired.

According to at least one of the various embodiments of the present disclosure, the acquiring of the first data can comprise providing a tool according to a capture request for a screen that is being provided on a display; and acquiring the first data from one area within a selected screen using the tool.

According to at least one of the various embodiments of the present disclosure, the first data can be acquired by downloading from the server.

According to at least one of the various embodiments of the present disclosure, the method of operating a display device can further comprise acquiring input for the interface; and providing a list of recommendations including executable functions and applications for the first data acquired according to the input for the acquired interface.

According to at least one of the various embodiments of the present disclosure, the searching of second data corresponding to the first data from the screen being provided can be executed only when a request for setting a search routine is acquired.

According to at least one of the various embodiments of the present disclosure, the first data can be in at least one of formats of image, text, and voice.

According to at least one of the various embodiments of the present disclosure, when predetermined data is searched (or detected) from an information area such as content provided through a screen, a routine corresponding to the searched data is automatically executed, thereby improving convenience of the user's use of the display device.

### BRIEF DESCRIPTION OF THE DRAWINGS

FIG. 1 is a block diagram showing a configuration of a display device according to an embodiment of the present disclosure.

FIG. 2 is a block diagram of a remote control device according to an embodiment of the present disclosure.

FIG. 3 shows an actual configuration example of a remote control device according to an embodiment of the present disclosure.

FIG. 4 shows an example of using a remote control device according to an embodiment of the present disclosure.

FIG. 5 is a diagram illustrating a horizontal mode and a vertical mode of a stand-type display device according to an embodiment of the present disclosure.

FIG. 6 is a diagram illustrating a search data-based routine processing system according to an embodiment of the present disclosure.

FIG. 7 is a flowchart illustrating an operating method of a display device according to an embodiment of the present disclosure.

FIGS. 8 to 11 are diagrams illustrating an automatic routine execution operation of a display device according to a user's capture operation according to an embodiment of the present disclosure.

FIGS. 12 to 22 are diagrams illustrating a screen configuration related to the operation of the display device in FIGS. 7 to 11 described above.

### DETAILED DESCRIPTION OF THE PREFERRED EMBODIMENTS

Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

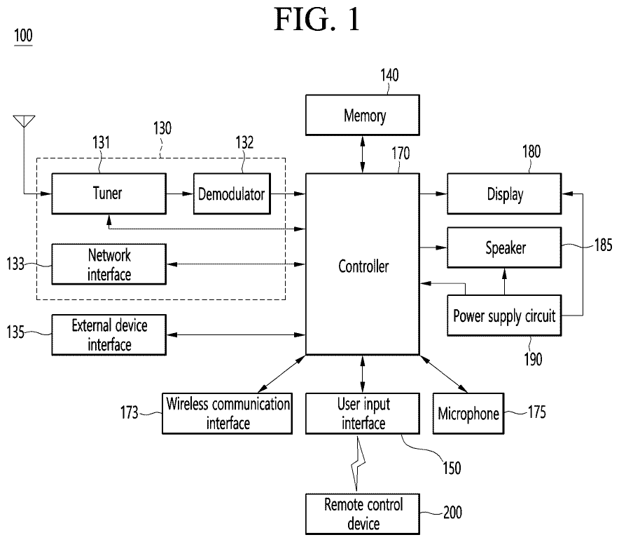

FIG. 1 is a block diagram showing a configuration of a display device according to an embodiment of the present disclosure.

Referring to FIG. 1, a display device 100 may include a broadcast receiver 130, an external device interface 135, a memory 140, a user input interface 150, a controller 170, a wireless communication interface 173, a display 180, a speaker 185, and a power supply circuit 190.

The broadcast receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The network interface 133 may provide an interface for connecting the display device 100 to a wired/wireless network including an Internet network. The network interface 133 may transmit or receive data to or from other users or other electronic devices through a connected network or another network linked to the connected network.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a contents provider or a network operator. That is, the network interface 133 may receive content such as movies, advertisements, games, VOD, and broadcast signals and information related thereto provided from a contents provider or a network provider through a network.

In addition, the network interface 133 may receive update information and update files of firmware provided by the network operator, and may transmit data to an Internet or contents provider or a network operator.

The network interface 133 may select and receive a desired application from among applications that are open to the public through a network.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is only an example.

In addition, a part of content data stored in the display device 100 may be transmitted to a selected user among a selected user or a selected electronic device among other users or other electronic devices registered in advance in the display device 100.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication interface 173 may detect (or recognize) a wearable device capable of communication around the display device 100. Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The voice acquisition interface 175 can acquire audio. The voice acquisition interface 175 can include at least one microphone (not shown) and can acquire audio around the display device 100 through the microphone (not shown).

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play the same.

For example, the display device 100 may be divided into an image processing device, such as a set-top box, for receiving broadcast signals or content according to various network services, and a content playback device that plays content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 and the speaker 185.

The audio output interface 185 receives a signal processed by the controller 170 and outputs it as voice.

The power supply circuit 190 supplies the corresponding power to the entire display device 100. In particular, power can be supplied to the controller 170 that can be implemented in the form of a system on chip (SOC), the display 180 for displaying images, and the audio output interface 185 for audio output.

Specifically, the power supply circuit 190 can be equipped with a converter that converts AC power into DC power and a dc/dc converter that converts the level of the DC power.

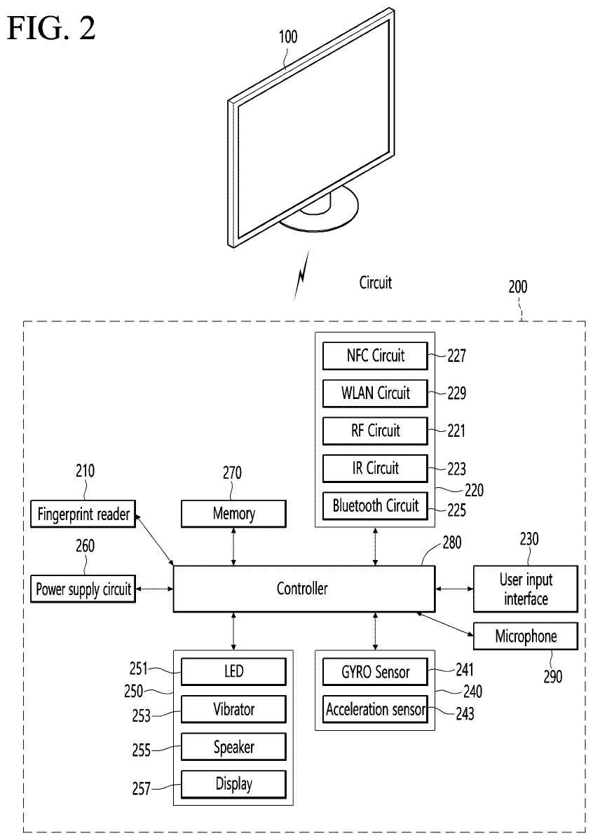

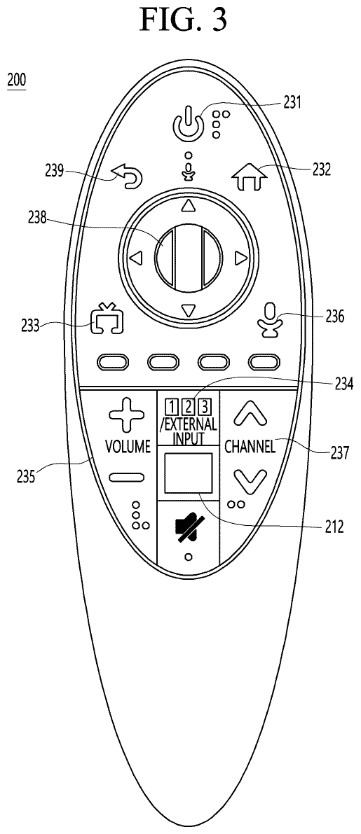

Next, a remote control device according to an embodiment of the present disclosure will be described with reference to FIGS. 2 to 3.

FIG. 2 is a block diagram of a remote control device according to an embodiment of the present disclosure, and FIG. 3 shows an actual configuration example of a remote control device 200 according to an embodiment of the present disclosure.

First, referring to FIG. 2, the remote control device 200 may include a fingerprint reader 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 may transmit and receive signals to and from any one of display devices according to embodiments of the present disclosure described above.

The remote control device 200 may include an RF circuit 221 capable of transmitting and receiving signals to and from the display device 100 according to the RF communication standard, and an IR circuit 223 capable of transmitting and receiving signals to and from the display device 100 according to the IR communication standard. In addition, the remote control device 200 may include a Bluetooth circuit 225 capable of transmitting and receiving signals to and from the display device 100 according to the Bluetooth communication standard. In addition, the remote control device 200 may include an NFC circuit 227 capable of transmitting and receiving signals to and from the display device 100 according to the NFC (near field communication) communication standard, and a WLAN circuit 229 capable of transmitting and receiving signals to and from the display device 100 according to the wireless LAN (WLAN) communication standard.

In addition, the remote control device 200 may transmit a signal containing information on the movement of the remote control device 200 to the display device 100 through the wireless communication circuit 220.

In addition, the remote control device 200 may receive a signal transmitted by the display device 100 through the RF circuit 221, and transmit a command regarding power on/off, channel change, volume adjustment, or the like to the display device 100 through the IR circuit 223 as necessary.

The user input interface 230 may include a keypad, a button, a touch pad, a touch screen, or the like. The user may input a command related to the display device 100 to the remote control device 200 by operating the user input interface 230. When the user input interface 230 includes a hard key button, the user may input a command related to the display device 100 to the remote control device 200 through a push operation of the hard key button.

Details will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back-play button 239.

The fingerprint recognition button 212 may be a button for recognizing a user's fingerprint. In one embodiment, the fingerprint recognition button 212 may enable a push operation, and thus may receive a push operation and a fingerprint recognition operation. The power button 231 may be a button for turning on/off the power of the display device 100. The home button 232 may be a button for moving to the home screen of the display device 100. The live button 233 may be a button for displaying a real-time broadcast program. The external input button 234 may be a button for receiving an external input connected to the display device 100. The volume control button 235 may be a button for adjusting the level of the volume output by the display device 100. The voice recognition button 236 may be a button for receiving a user's voice and recognizing the received voice. The channel change button 237 may be a button for receiving a broadcast signal of a specific broadcast channel. The OK button 238 may be a button for selecting a specific function, and the back-play button 239 may be a button for returning to a previous screen.

A description will be given referring again to FIG. 2.

When the user input interface 230 includes a touch screen, the user may input a command related to the display device 100 to the remote control device 200 by touching a soft key of the touch screen. In addition, the user input interface 230 may include various types of input means that may be operated by a user, such as a scroll key or a jog key, and the present embodiment does not limit the scope of the present disclosure.

The sensor 240 may include a gyro sensor 241 or an acceleration sensor 243, and the gyro sensor 241 may sense information regarding the movement of the remote control device 200.

For example, the gyro sensor 241 may sense information about the operation of the remote control device 200 based on the x, y, and z axes, and the acceleration sensor 243 may sense information about the moving speed of the remote control device 200. Meanwhile, the remote control device 200 may further include a distance measuring sensor to sense the distance between the display device 100 and the display 180.

The output interface 250 may output an image or audio signal corresponding to the operation of the user input interface 230 or a signal transmitted from the display device 100.

The user may recognize whether the user input interface 230 is operated or whether the display device 100 is controlled through the output interface 250.

For example, the output interface 450 may include an LED 251 that emits light, a vibrator 253 that generates vibration, a speaker 255 that outputs sound, or a display 257 that outputs an image when the user input interface 230 is operated or a signal is transmitted and received to and from the display device 100 through the wireless communication circuit 220.

In addition, the power supply circuit 260 may supply power to the remote control device 200, and stop power supply when the remote control device 200 has not moved for a predetermined time to reduce power consumption. The power supply circuit 260 may restart power supply when a predetermined key provided in the remote control device 200 is operated.

The memory 270 may store various types of programs and application data required for control or operation of the remote control device 200. When the remote control device 200 transmits and receives signals wirelessly through the display device 100 and the RF circuit 221, the remote control device 200 and the display device 100 transmit and receive signals through a predetermined frequency band.

The controller 280 of the remote control device 200 may store and refer to information on a frequency band capable of wirelessly transmitting and receiving signals to and from the display device 100 paired with the remote control device 200 in the memory 270.

The controller 280 may control all matters related to the control of the remote control device 200. The controller 280 may transmit a signal corresponding to a predetermined key operation of the user input interface 230 or a signal corresponding to the movement of the remote control device 200 sensed by the sensor 240 through the wireless communication circuit 220.

Also, the microphone 290 of the remote control device 200 may obtain a speech.

A plurality of microphones 290 may be provided.

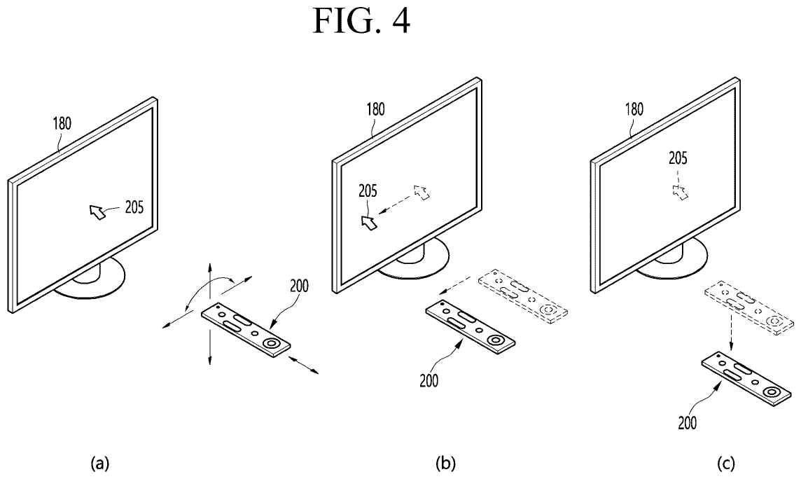

Next, a description will be given referring to FIG. 4.

FIG. 4 shows an example of using a remote control device according to an embodiment of the present disclosure.

In FIG. 4, (a) illustrates that a pointer 205 corresponding to the remote control device 200 is displayed on the display 180.

The user may move or rotate the remote control device 200 up, down, left and right. The pointer 205 displayed on the display 180 of the display device 100 may correspond to the movement of the remote control device 200. As shown in the drawings, the pointer 205 is moved and displayed according to movement of the remote control device 200 in a 3D space, so the remote control device 200 may be called a space remote control device.

In (b) of FIG. 4, it is illustrated that that when the user moves the remote control device 200 to the left, the pointer 205 displayed on the display 180 of the display device 100 moves to the left correspondingly.

Information on the movement of the remote control device 200 detected through a sensor of the remote control device 200 is transmitted to the display device 100. The display device 100 may calculate the coordinates of the pointer 205 based on information on the movement of the remote control device 200. The display device 100 may display the pointer 205 to correspond to the calculated coordinates.

In (c) of FIG. 4, it is illustrated that a user moves the remote control device 200 away from the display 180 while pressing a specific button in the remote control device 200. Accordingly, a selected area in the display 180 corresponding to the pointer 205 may be zoomed in and displayed enlarged.

Conversely, when the user moves the remote control device 200 to be close to the display 180, the selected area in the display 180 corresponding to the pointer 205 may be zoomed out and displayed reduced.

On the other hand, when the remote control device 200 moves away from the display 180, the selected area may be zoomed out, and when the remote control device 200 moves to be close to the display 180, the selected area may be zoomed in.

Also, in a state in which a specific button in the remote control device 200 is being pressed, recognition of up, down, left, or right movements may be excluded. That is, when the remote control device 200 moves away from or close to the display 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

Meanwhile, in the present specification, a pointer refers to an object displayed on the display 180 in response to an operation of the remote control device 200. Accordingly, objects of various shapes other than the arrow shape shown in the drawings are possible as the pointer 205. For example, the object may be a concept including a dot, a cursor, a prompt, a thick outline, and the like. In addition, the pointer 205 may be displayed corresponding to any one point among points on a horizontal axis and a vertical axis on the display 180, and may also be displayed corresponding to a plurality of points such as a line and a surface.

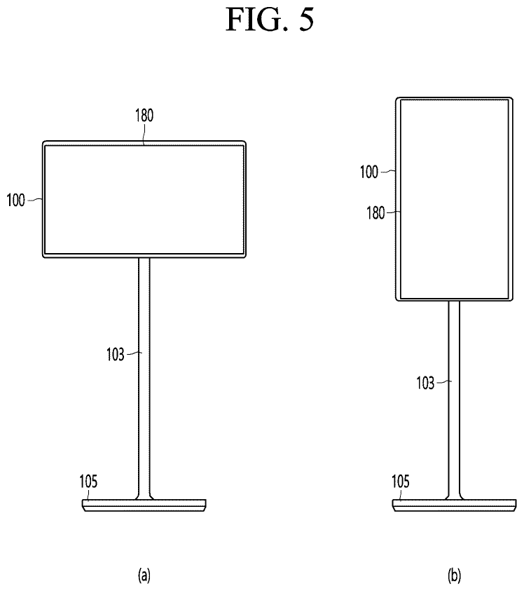

FIG. 5 (a) and FIG. 5 (b) are drawings for explaining a horizontal mode and a vertical mode of the stand-type display device according to the embodiment of the present disclosure.

Referring to FIG. 5 (a) and FIG. 5 (b), a stand-type display device 100 is illustrated.

A shaft 103 and a stand base 105 may be connected to the display device 100.

The shaft 103 may connect the display device 100 and the stand base 105. The shaft 103 may be extended vertically.

The lower end of the shaft 103 may be connected to the edge of the stand base 105.

The lower end of the shaft 103 may be rotatably connected to a circumference of the stand base 105.

The display device 100 and the shaft 103 can rotate around a vertical axis with respect to the stand base 105.

The upper portion of the shaft 103 can be connected to the rear of the display device 100.

The stand base 105 can serve to support the display device 100.

The display device 100 can be configured to include the shaft 103 and the stand base 105.

The display device 100 can rotate around a point where the upper portion of the shaft 103 and the rear of the display 180 meet.

FIG. 5 (a) may indicate that the display 180 operates in a horizontal mode in which the horizontal length is greater than the vertical length, and FIG. 5 (b) may indicate that the display 180 operates in a vertical mode in which the vertical length is greater than the horizontal length.

The user may move the stand-type display device 100. That is, unlike fixed devices, the stand-type display device 100 has improved mobility, so the user is not restricted by the placement location.

Next, a display device 100 and an operating method thereof are described in which, when predetermined data is searched (or detected) (hereinafter referred to as “search”) from an information area such as content provided through a screen, a routine corresponding to the searched data is executed.

At this time, the predetermined data may represent pre-stored data. Such data may include data such as captured images, audio, text, or a combination thereof, but is not limited thereto.

The routine corresponding to the searched data may indicate that preset operation(s) are executed for the searched data. This routine may indicate that the searched data is the predetermined data described above, and the operation(s) set for the predetermined data in advance.

Hereinafter, various embodiments of a routine processing operation method corresponding to the searched data of the display device 100 are disclosed, but are not necessarily limited thereto.

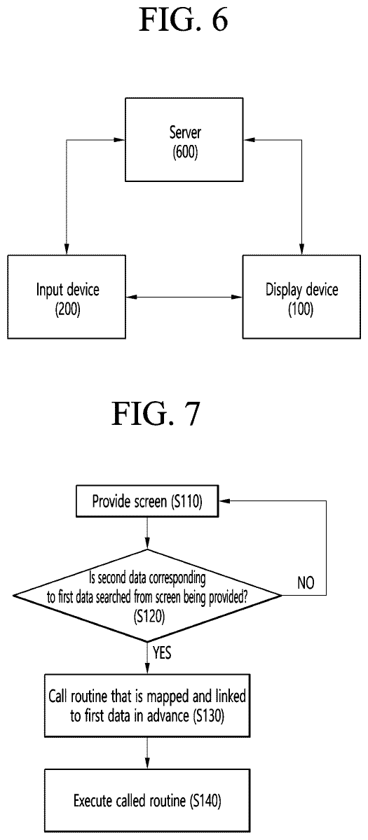

FIG. 6 is a drawing illustrating a search data-based routine processing system according to an embodiment of the present disclosure.

Referring to FIG. 6, the search data-based routine processing system may be configured to include a display device 100, an input device 200, and a server 600.

The display device 100 may be the display device described in FIG. 1 or 5.

The input device 200 may be or include the remote control device 200 described in FIGS. 2 to 4. In addition, the input device 200 may include a smartphone held by a user.

However, the display device and the input device according to the present disclosure are not limited to those described above.

The operation of the search data-based routine processing system is briefly described as follows.

Users, etc. can set data to be monitored or searched when the display device 100 is in operation through the input device 200.

For example, the user can select (e.g., capture, etc.) a predetermined area or object within the screen currently provided by the display device 100 using a remote control device 200 such as FIG. 2 and save it as search data.

As described above, when the user saves search data, the display device 100 can guide the routine setting and help the user set the routine when the user selects it. That is, when the user saves search data, the display device 100 can set the routine by mapping the operations (or automatic operations) to be performed when the search data saved by the display device 100 is searched later. The operations set in the routine can be automatically executed when the corresponding search data is searched.

The server 600 can be in charge of at least some of the functions of the display device 100 described above. Alternatively, the server 600 may receive search data stored by the user in the display device 100, routine data set for the search data, etc. from the display device 100, and store them. When data corresponding to the stored search data is searched later in the display device 100, the server 600 may transmit the previously stored routine data or transmit an operation control signal according to the routine to the display device 100. When receiving the operation control signal from the server 600, the display device 100 may parse it and perform a corresponding operation.

Meanwhile, when data corresponding to the search data stored in advance in the display device 100 is searched, the server 600 may unconditionally transmit a routine operation control signal according to the previously stored routine data to the display device 100.

Alternatively, when data corresponding to search data stored in advance in the display device 100 is searched, the server 600 may control to transmit a routine operation control signal according to the routine data to the display device 100 by recognizing the current situation and understanding the user's intention, rather than unconditionally transmitting the routine operation control signal to the display device 100. In the case where there are multiple routine operations mapped to the search data, this control may include controlling to perform the routine operations sequentially, but may also include controlling to filter out the routine operations mapped with a higher priority and perform the routine operations mapped with a lower priority immediately, depending on the case. For example, if it is determined that some of the content currently being played on the display device 100 and some of the routine operations set do not match the user's intention due to resource issue, a separate content agreement such as a simultaneous execution restriction, bandwidth issue, current time, weather, etc., it may briefly guide the user and immediately perform another routine operation.

The following describes in more detail the operation method of the display device 100 according to one embodiment of the present disclosure.

FIG. 7 is a flow chart illustrating an operation method of a display device 100 according to an embodiment of the present disclosure.

FIG. 7 is described from the perspective of the display device 100 for convenience of explanation. However, it is not limited thereto.

In step S110, the display device 100 can provide a screen.

Here, the screen can include an execution screen of all applications provided after the display is turned on, such as a broadcast program screen, an application execution screen, an Internet screen, a gallery screen, etc.

In step S120, the display device 100 can determine whether second data corresponding to first data is searched from the screen being provided.

Here, the first data can be data selected by a user from a screen being provided by the display device 100 through an input device 200, etc., or selected from a smartphone, etc., and designated as search data and stored, as described above in FIG. 6.

The second data may represent data identical or similar to the first data.

Alternatively, the second data may include at least a portion of the same data or area as the first data.

Although not shown, if the first data is set and stored as search data and even a routine is set, the display device 100 may search for second data corresponding to the first data on all subsequent screens. At this time, the second data may also include first data candidate data. For example, the candidate data may represent data that is less than or more than a threshold value but not completely identical when the display device 100 determines whether there is second data corresponding to the first data.

In step S130, if the display device 100 determines that the second data is searched in step S120, the display device 100 may call a routine that is mapped and linked in advance to the first data.

The called routine may have all of the set routine operations, but can be played sequentially.

Alternatively, the routine may be called only for the top-level routine operation, and then sequentially called the next-priority routine operation.

In step S140, the display device 100 may execute the called routine.

The display device 100 may execute the called routine, but may provide the routine by switching the screen. In this case, the screen switching may be notified or guided in advance.

The display device 100 may execute the called routine, but in the case of concurrently executable routine operations, may execute them simultaneously through mode switching such as multi-view, PIP (Picture in Picture), POP (Picture of Picture), pop-up window, etc. Audio may be prioritized for the application or function according to the routine operation, or may not be. Control of such audio output may be based on the user's settings.

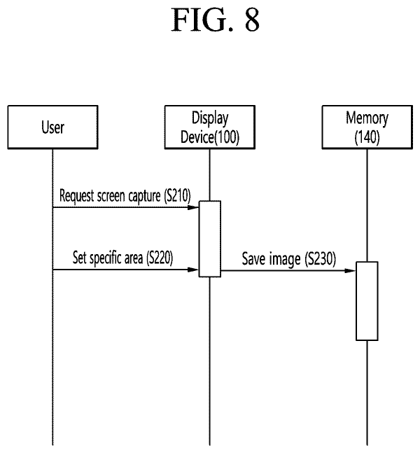

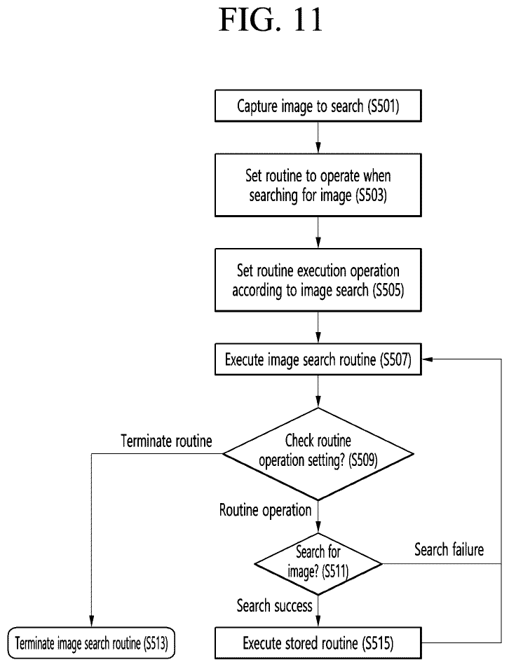

FIGS. 8 to 11 are diagrams illustrating routine automatic execution operations of a display device 100 according to a user's capture operation according to an embodiment of the present disclosure.

First, FIG. 8 describes an operation of storing search data according to a user's request in the display device 100.

In step S210, the display device 100 can receive a screen capture request from the user.

At this time, the user can indicate an input device of FIG. 6, such as a remote control device 200.

Meanwhile, step S210 can be replaced by search data uploaded to the display device 100 or server 600 by the user.

In step S220, the display device 100 can be set a specific area in response to the screen capture request of step S210.

That is, the display device 100 can execute a screen capture application according to step S210 to provide an execution screen of a related function and set a specific area to be captured by the user.

In step S230, if the display device 100 captures a specific area set through steps S210 and S220, the display device 100 can store the captured image in the memory 140.

At this time, an editing tool may be provided for the captured image stored in the memory 140 to set it as search data. For example, if the area to be set as search data among the captured images is edited and finally selected, the image of the selected area can be stored in the memory 140 finally.

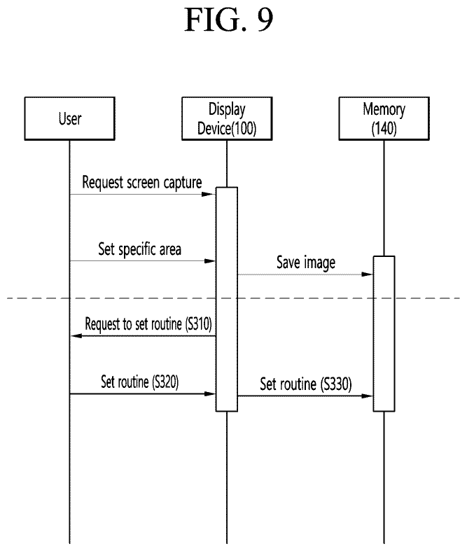

Next, FIG. 9 describes the processing operation for the image captured and stored in

FIG. 8.

Referring to FIG. 9, in step S310, the display device 100 can request routine setting to the user (or the input device (200)).

In step S320, the display device 100 can provide data for routine setting to the user and receive data for the routine to be set.

At this time, the data for routine setting can be provided in a pop-up window or other manner. For example, data related to routine setting is illustrated in FIGS. 16 to 19.

However, according to the embodiment, when the image is stored or designated as search data and stored in step S230 of the aforementioned FIG. 8, the display device 100 can provide data for routine setting only when there is a request for routine setting from the user.

In step S330, the display device 100 can map the routine set by the user to the pre-stored image and store it in the memory 140.

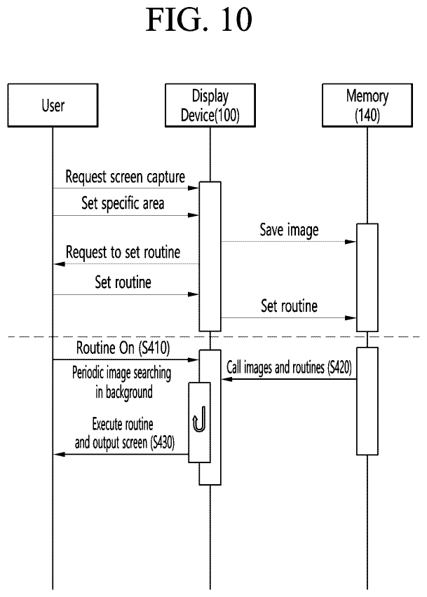

Next, FIG. 10 is a drawing for explaining the display operation after FIGS. 8 and 9. In step S410, the display device 100 can receive a routine on request by the user. Here, the routine on request can be, for example, a trigger signal that controls the pre-stored search data-routine execution algorithm according to the present disclosure to operate.

According to an embodiment, the display device 100 can perform an operation of searching data designated as search data from the screen even without a trigger such as the routine on request of step S410. In this case, when the data designated as search data is searched or candidate search data is searched, a guide which is asking whether to execute the routine is provided, and the routine can be executed or not executed depending on the selection.

In step S420, the display device 100 can call a search data-routine combination to be used as search data or designated when a routine on request is received from the user in step S410.

In step S430, the display device 100 can execute the routine and output the screen.

Meanwhile, before executing the routine and providing the screen of step S430, the display device 100 can continuously perform an image search operation in the background. The performance of this image search operation can be performed, for example, for a predefined time, until the end of the current content, until an advertisement is played, or until a specific event occurs. In addition, the specific event can be any one of a user's request to stop image search, turning off of the display device, a new content playback request, a screen switching, etc.

Meanwhile, according to an embodiment, instead of loading both the image and the routine, only the image is called and used for image search, and only when at least one corresponding image or candidate search image is searched, the routine data mapped to the image can be called.

Next, FIG. 10 describes the entirety of FIGS. 8 to 10 described above.

In step S501, the display device 100 can capture an image to be searched. This can be done by the user's request. Alternatively, the object(s) included in the screen can be automatically captured based on the results learned by the server 600 or the artificial intelligence engine (not shown) included in the display device 100. The learning can be done for images mainly captured by users belonging to the server 600 or using the display device 100 or preferred images according to the user's unique characteristics.

In step S503, the display device 100 can set a routine to be operated when searching for an image if capture is made in step S501.

In step S505, the display device 100 can set a routine execution operation according to the image search.

In step S507, the display device 100 can execute the image search routine.

In step S509, the display device 100 can check the routine operation setting.

In step S513, if the routine is terminated as a result of the checking, the display device 100 can terminate the image search routine.

In step S511, if the routine is in operation as a result of the checking, the display device 100 can search for an image.

In step S515, if the search is successful as an image search result in step S511, the display device 100 can execute the stored routine.

In contrast, if the search fails as an image search result in step S511, the display device 100 can return to step S507.

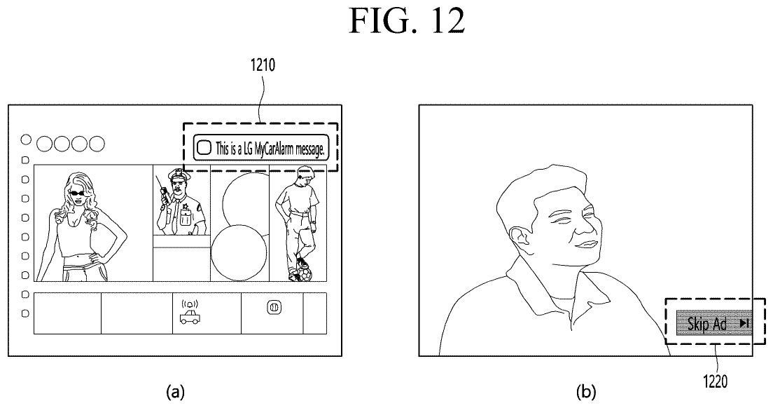

FIGS. 12 to 22 are drawings illustrating screen configurations related to the operation of the display device 100 in FIGS. 7 to 11 described above.

First, FIGS. 12 to 15 are drawings related to acquiring search data used in an image search routine.

In (a) and (b) of FIG. 12, when a user's image capture request is received, the display device 100 provides a tool for image capture and can capture a predetermined area 1210, 1220 as illustrated.

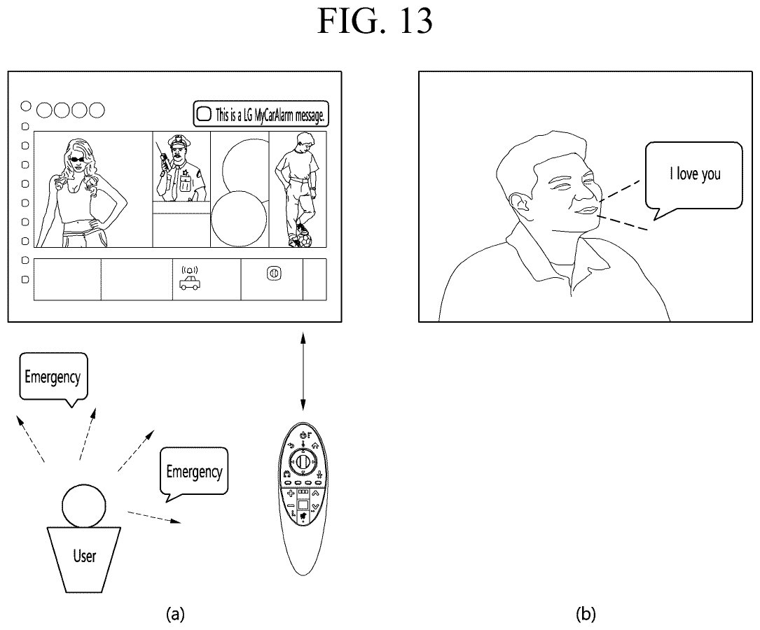

FIG. 13, unlike FIG. 12, explains acquiring search data used in a search routine through a different input means.

In FIG. 13 (a), the user directly sets search data by voice through the display device 100 or the input device 200.

In this case, if there is a data area 1310 corresponding to the voice on the screen of the display device 100, an identification mark may be provided as in the aforementioned FIG. 12.

However, in FIG. 13 (a), the setting of the search data may be unrelated to the screen currently being provided.

On the other hand, in FIG. 13 (b), the search data may be set from the audio output of a character or corresponding content appearing on the screen currently being provided, not the user.

In this case, the audio itself may be set as the search data to be used in the search routine.

Alternatively, the text corresponding to the audio, not the audio itself, may be set as the search data to be used in the search routine.

For example, in FIG. 13 (b), if the character appearing on the screen says “I love you,” the content of FIG. 13 (b) may be applied to FIG. 13 (a) in the same or similar manner.

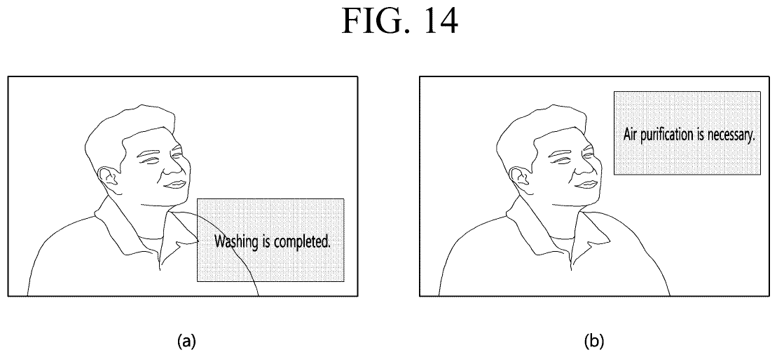

FIG. 14 is a drawing illustrating an embodiment of a control for linking with an IoT device that can be linked with a display device 100.

The display device 100 may be linked with various IoT devices in advance. Here, the IoT devices may include, for example, various home appliances belonging to a common network (or the same network). Such home appliances may include all devices that can be linked or have the potential to be linked with the display device 100, such as a washing machine, an air conditioner, a refrigerator, an air purifier, etc.

FIG. 14 (a) shows, for example, when washing is completed in a washing machine linked with the display device 100, if a pop-up window saying “Washing is completed.” appears on the screen, the display device 100 can automatically capture this. Thereafter, the display device 100 can map and store the captured text and the mapped operation. At this time, the mapped operation represents the operation of the display device 100, but the operation of the display device 100 may be, for example, an operation for controlling a washing machine. For example, if the display device 100 displays a pop-up window on the screen, and the pop-up window includes the above phrase, and then the display device 100, a pre-mapped operation, that is, may transmit an operation control signal such as turning off the washing machine power to the washing machine.

In FIG. 14 (b), for example, when an air purifier connected to the display device 100 determines that air purification is necessary and transmits a signal including the text “Air purification is necessary.” to the display device 100, a pop-up window including the text may be displayed. The display device 100 may automatically capture this. Thereafter, the display device 100 may map and store the captured text and the operation to be mapped. At this time, the mapped operation represents the operation of the display device 100, but the operation of the display device 100 may be, for example, an operation for controlling the air purifier. For example, if the display device 100 displays a pop-up window on the screen, and the pop-up window includes the above phrase, and then the display device 100, a pre-mapped operation, that is, may transmit an operation control signal such as turning on the air purifier power to the air purifier.

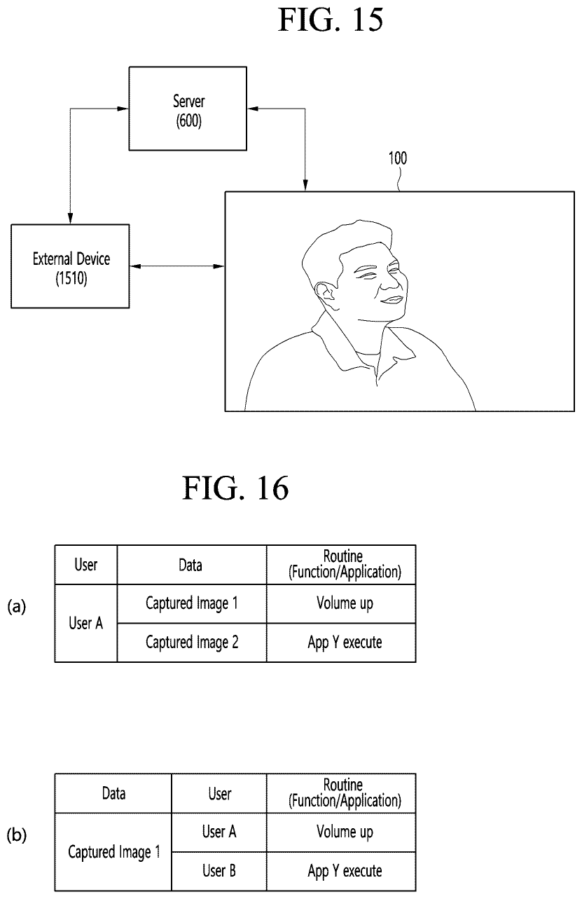

FIG. 15 may be an embodiment related to acquiring search data used in a search routine, for example.

In the above-described embodiments, the search data used in the search routine was disclosed for example, such as a user's capture request or voice input, but in FIG. 15, the search data used in the search routine may be directly transmitted from an external device 1510 to a server 600 or the display device 100.

If the external device 1510 is a smart phone held by the user, the user may transmit images, texts, voices, etc. that have been previously saved or captured while using the smart phone 1510 to the server 600 or the display device 100, thereby utilizing them as search data for the search routine of the display device 100.

The user may capture the text “skip” while using a specific application through the smart phone 1510, and request that it be transmitted to the server 600 or the display device 100 and stored as search data used in the search routine. The display device 100 may receive a request through the server 600 or directly from the smart phone 1510, and may map and store at least one routine operation as described above.

Therefore, if the image or text “skip” is searched for in the search routine from the screen output thereafter, the display device 100 may perform the previously mapped routine operation.

In FIGS. 16 to 19, examples of mapping of search data (i.e., search words) and routine operations used in a search routine are illustrated.

First, in FIG. 16 (a), it is exemplified that routine operations such as different functions or applications are mapped to each of multiple captured images based on one user.

Meanwhile, in FIG. 16 (b), it is an example in which different functions or applications are mapped to multiple users (User A, User B) based on captured images, not based on users. That is, in FIG. 16 (b), it can be shown that different routine operations can be performed depending on the user for the same captured image.

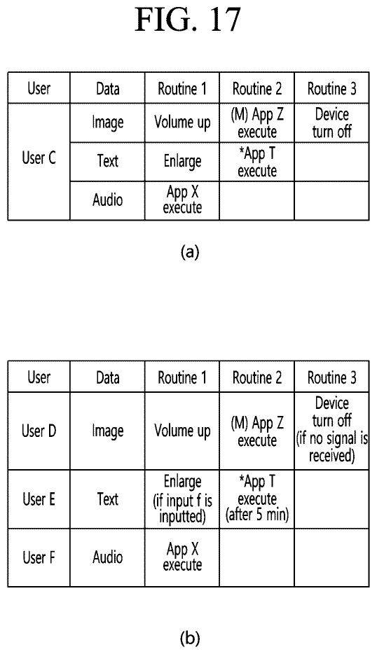

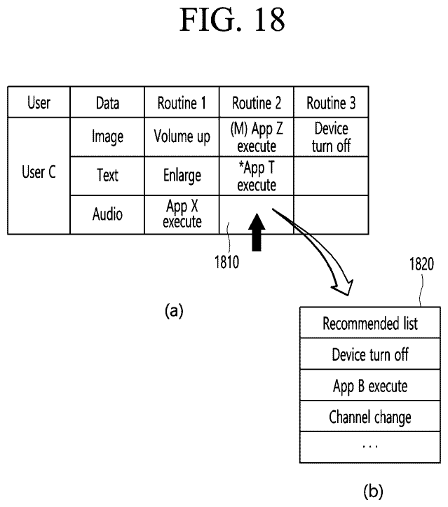

In FIGS. 17 and 18, the operation of the display device 100 in the routine setting process is disclosed.

FIG. 17 (a) explains that the routine operation set or mapped may vary depending on the data type for one user (User C). Here, the data type may include, for example, an image, text, audio, etc. In other words, in FIG. 17 (a), it can be seen that the routine operation set or mapped varies depending on the data type being an image, text, and audio.

Meanwhile, in FIG. 17 (a), M indicates a recommendation in multi-view mode, and * indicates a recommended application or function.

Meanwhile, FIG. 17 (b) indicates that various routine operations can be set depending on the user and data type.

FIG. 18 (a) is the same as FIG. 17 (a) described above. At this time, if the user selects a blank space 1810 using, for example, a pointer in FIG. 18 (a) or the like, a recommended routine operation list 1820 such as FIG. 18 (b) may be provided.

The recommended routine operation included in the recommended routine operation list 1820 illustrated in FIG. 18 (b) may be a list of functions or applications determined by considering, for example, resources, concurrent execution availability, users, data types, previous setting routines, and user intentions. At this time, the order may be provided so that they are sequentially exposed starting from the one with the highest recommendation priority.

The recommended routine operation included in the recommended routine operation list 1820 may be, for example, arbitrary, and the order may also be random.

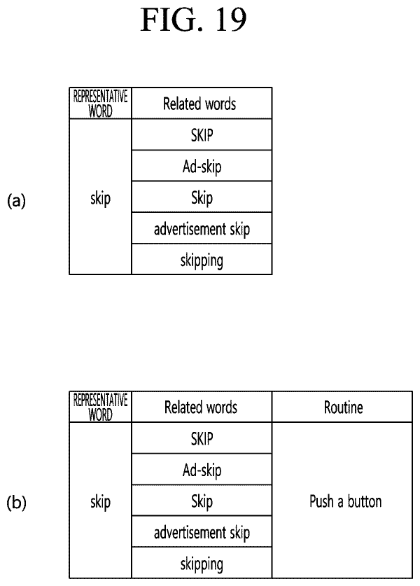

FIG. 19 describes setting a routine based on the representative search word setting.

The display device 100 can execute a representative search word grouping function according to the setting or user's request, for example, related words.

The representative search word grouping function means that, for example, when a user registers an English word ‘skip’ in FIG. 19 (a), related words, such as synonyms, derivatives, similar words, and foreign words, are grouped into a subgroup of the representative word and can be judged to have the same meaning. For example, the English word skip as a representative search word can be treated as the same search word by including capital letters SKIP, Ad-skip, Skip, advertisement skip, skipping, etc. as subgroups.

Therefore, as in FIG. 19 (b), the same routine operation can be set for search words belonging to a subgroup (related word) based on the representative word Skip. However, it is not necessarily limited to this, and other routines may be arbitrarily set depending on the device or the user's settings.

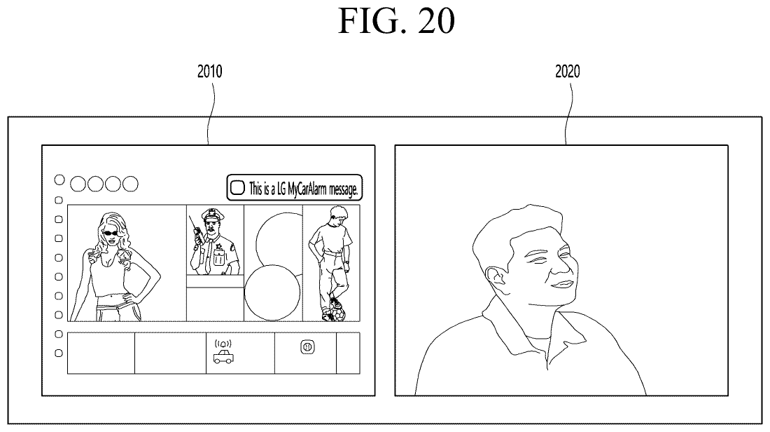

FIG. 20 is a drawing illustrating a screen in which a multi-view mode is executed as one of the routine operations when a search word is searched according to a search routine according to the present disclosure.

Referring to FIG. 20, the display device 100 can execute the multi-view mode to confirm the intention or intent of the user currently consuming the content without switching the currently being provided screen to the routine operation screen, if the set routine operation includes execution of a multi-view mode, or if the currently provided screen 2010 and the operation (function or application execution, etc.) 2020 set as the routine operation for the search word searched by the search routine are determined to be capable of simultaneous playback.

In addition, the multi-view of FIG. 20, for example, when User A (main user) and User B are watching content C, and a search word registered by User B, not User A, is searched in content C according to a search routine, the operation set for the search word registered by User B can be provided simultaneously as in FIG. 20 in a multi-view to minimize the interruption of the content being consumed by the main user, or the operation can be provided as a PIP or POP on the screen of content C.

In FIGS. 16 and 17, the user can be replaced with, for example, the IoT device described above.

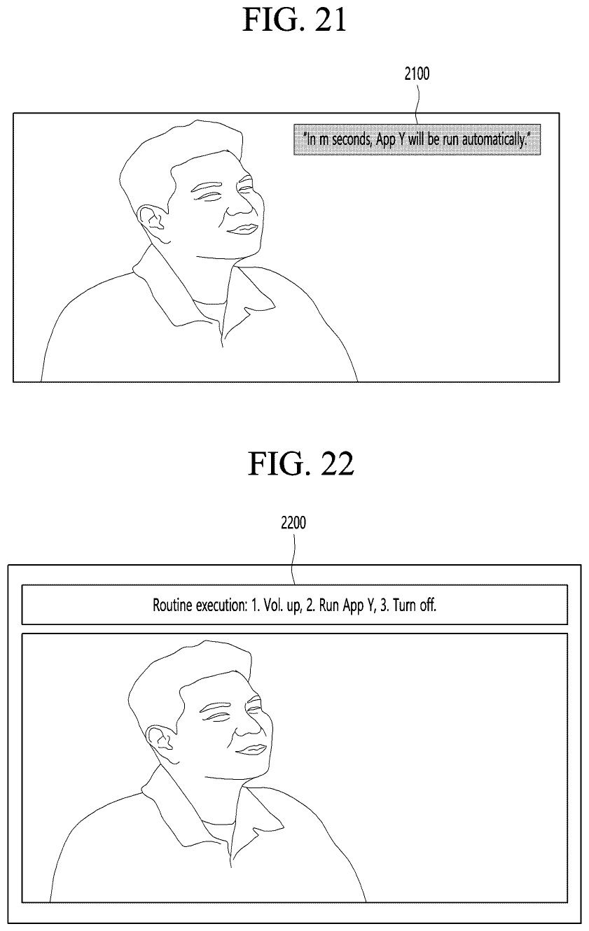

In FIG. 21, when a search word is searched according to a search routine on a display device 100, the routine operation is not immediately executed, but rather a screen that guides 2100 that the search word has been searched and that the routine operation set accordingly is scheduled to be automatically executed.

FIG. 22 may provide a list 2200 of routine operations, similar to FIG. 21, when there are multiple routine operations mapped or set to the searched search word. At this time, the user may request to execute a desired routine first regardless of the order of routine operations, and the display device 100 may perform the requested routine operation first accordingly.

The search routine and routine operation execution according to the present disclosure may typically depend on the channel or application execution screen that the current user is watching.

According to an embodiment, the search routine and routine operation execution may typically not depend on the channel or application execution screen that the current user is watching. For example, suppose that the current user is watching channel A and the search routine is currently being executed. In this case, if data searchable through the search routine is being output or included in channel B, which is provided at the same time as the channel A that the user is watching, this may be guided to the user and an operation may be performed accordingly. According to an embodiment, channel B may be an adjacent channel of channel A.

Meanwhile, the user or the display device 100 can manually or automatically select search data to be applied to the search routine from among the plurality of search data according to the screen currently being provided. For example, suppose that the user has saved 10 search data to be applied to the search routine through capture, etc. In this case, only some of the search data for the 10 saved search routines can be activated and applied to the search routine according to at least one or a combination of the screen properties, application properties, current user or status of display device 100, time information, weather information, and location information. At this time, if no search results are found among the activated search data, other search data that were deactivated can be activated and applied to the search routine.

The above-described contents may be determined according to the order or priority of the search data.

In the present disclosure, if it is identified that multiple users are currently using the display device 100, the search routine results can be guided according to the priority or all search routine results can be guided, and the routine operation can be executed according to the selection.

In addition, urgent or preset search data among the search data for the search routine can always be included in the search routine.

Even if not specifically mentioned, the order of at least some of the operations disclosed in the present disclosure may be performed simultaneously or in a different order from the described order, or some may be omitted/added.

According to one embodiment of the present disclosure, the above-described method can be implemented as a code that can be read by a processor in a medium in which a program is recorded. Examples of the medium that can be read by a processor include a ROM, a RAM, a CD-ROM, a magnetic tape, a floppy disk, an optical data storage device, etc.

The display device described above is not limited to the configuration and method of the embodiments described above, and the embodiments may be configured by selectively combining all or some of the embodiments so that various modifications can be made.

What is claimed is:

1. A display device comprising:
a memory;
a display configured to provide a screen; and
a processor configured to call first data to be used in a search routine from the memory,
when second data corresponding to the first data is searched from the screen being provided, call information about at least one of functions and applications that are mapped and stored in advance with the first data from the memory, and
control the called function or application to be executed.

2. The display device according to claim 1, wherein the processor is configured to:
acquire the first data, and
control to provide an interface for setting up a routine by mapping at least one of an executable function and application to the first data acquired.

3. The display device according to claim 2, wherein the processor is configured to:
provide a tool according to a capture request for a screen that is being provided on the display, and
acquire the first data from one area within a selected screen using the tool.

4. The display device according to claim 2, wherein the processor is configured to download and acquire the first data from a server.

5. The display device according to claim 2, wherein the processor is configured to provide a list of recommendations including executable functions and applications for the first data acquired according to a selection for the interface.

6. The display device according to claim 1, wherein the processor is configured to search second data corresponding to the first data from the screen being provided when a request for setting a search routine is acquired.

7. The display device according to claim 1, wherein the first data is in a format of at least one of image, text and voice.

8. A method of operating a display device, comprising:
providing a screen;
calling first data to be used in a search routine;
searching for second data corresponding to the first data from the screen being provided;
calling information about at least one of functions and applications that are mapped and stored in advance with the first data when the second data is searched; and
executing a function or an application based on the called information.

9. The method of operating a display device according to claim 8, further comprising:
acquiring the first data, and
controlling to provide an interface for setting up a routine by mapping at least one of an executable function and application to the first data acquired.

10. The method of operating a display device according to claim 9, wherein the acquiring of the first data comprises:
providing a tool according to a capture request for a screen that is being provided on a display; and
acquiring the first data from one area within a selected screen using the tool.

11. The method of operating a display device according to claim 9, wherein the first data is acquired by downloading from the server.

12. The method of operating a display device according to claim 9, further comprising:
acquiring input for the interface; and
providing a list of recommendations including executable functions and applications for the first data acquired according to the input for the acquired interface.

13. The method of operating a display device according to claim 8, wherein the searching of second data corresponding to the first data from the screen being provided is executed only when a request for setting a search routine is acquired.

14. The method of operating a display device according to claim 8, wherein the first data is in a format of at least one of image, text and voice.
